(19) United States
(12) Patent Application Publication
(10) Pub. No.: US 2006/0107872 A1
(43) Pub. Date: May 25, 2006

(54) Method and apparatus for producing calcium silicate hydrate

(76) Inventor: Hong Chen, New South Wales (AU)

Correspondence Address: GARDERE / JAMES HARDIE;GARDERE WYNNE SEWELL, LLP, 1601 ELM STREET, SUITE 3000, DALLAS, TX, 75201, US

(21) Appl. No.: 10/534,421

(22) PCT Filed: Nov. 5, 2003
(86) PCT No.: PCT/AU03/01456

§ 371 Date: May 5, 2005

Related U.S. Application Data
(60) Provisional application No. 60/424,056, filed on Nov. 5, 2002.

(51) Int. Cl. C09C 1/02; C04B 28/26

(52) U.S. Cl. 106/470; 106/600

(57) ABSTRACT

A method and apparatus for producing calcium silicate hydrate. A calcareous material is combined with a suspension or gel forming agent. The resultant gel is then combined with a siliceous material to form a preferably homogeneous reactive matrix. This matrix then undergoes elevated pressure and temperature to form calcium silicate hydrate without the need for mixing or agitation. The resultant calcium silicate hydrate has a high post reaction solids content of around 35% or higher.

### BACKGROUND OF THE INVENTION

1. Field of the Invention

The present invention relates to preparation of calcium silicate hydrate and particularly, but not only, preparation of calcium silicate hydrate with a high solids content.

2. Description of the Related Art

Medium density fiber cement products are in high demand in the building industry due to the inherent properties and the range of applications to which fiber cement can be applied. Some of the beneficial attributes of fiber cement include, resistance to warping, rotting, fire and moisture which are beneficial in applications as diverse as internal wet area linings, external cladding, trim, fencing, flooring, eaves and decking. One of the limitations of medium density fiber cement is the weight of the product relative to alternatives such as wood and vinyl.

The ability of manufacturers to convert all medium density fiber cement products to low density is limited due to the costs of providing the low density additives used in the manufacture of reduced-density fiber cement. One such additive is “Calsil”, an acronym for Calcium-Silicate (Hydrate), which is typically manufactured by combining slaked quicklime with silica and stirring in a vessel at elevated temperature and pressure for a predetermined time. This process (and equivalents) produce Calsil at a relatively high cost due to the use of a high cost stirred reactor and that fact that the slurry is formed with a low solids content, typically 10%.

In the prior art, the manufacture of calcium silicate products involves the formation of a dilute slurry by mixing in a stirred reactor a calcareous material with a siliceous material, such as sand, in water. This mixture is heated in an autoclave to form a variety of crystalline forms of calcium silicate depending upon the temperature, pressure, length of reaction time and water concentration used. Relevant patents describing the hydrothermal formation of calcium silicate hydrates and various aspects of the processing thereof include U.S. Pat. Nos. 4,574,012; 4,427,611; 4,490,320; 4,490,320; 4,629,508; 4,447,380; 4,131,638; 6,346,146 and EP0562112 and WO 96/11877.

In some cases, the prior art indicates that fibrous materials such as asbestos, which are not adversely affected by the reaction conditions, may be incorporated into the mixture prior to processing, or alternatively temperature-sensitive fibres can be added post processing directly to the slurry. The product of this processing is generally an aqueous slurry of hydrated calcium silicate crystals intermixed with desired fibrous components. This slurry is then cast into molds and dried, usually by heating, to form the desired finished shaped objects.

Calcium silicate hydrate crystals or agglomerates can be utilized for a variety of purposes other than molded or shaped products, for example U.S. Pat. Nos. 5,100,643; 5,401,481 and 5,047,222 form said article and harvest the crystals to use as a sorbent in gas streams to eliminate a noxious gas component. Other applications include directly using the formed calcium silicate slurry in papermaking as an opacifyer (PCT Patent No. WO01/14274) or using the slurry directly in a Hatschek machine to make low density fibre cement boards U.S. Pat. No. 6,346,146.

The commonality in the prior art is that calcium silicate hydrate articles are all produced in dilute slurries (typically around 10% solids content) with stirred reactors and then said article is recovered from the slurry to be used in the final product. Surprisingly, only a few inventors have attempted to overcome the problem of reducing or eliminating the drying requirement of the slurry of calcium silicate hydrate. Some of these methods include: pulsing the autoclave to drive moisture out of shaped calcium silicate bodies (European Patent No. EP0624561), altering the viscosity of the slurry to enable a higher solids slurry to be reacted in the autoclave (U.S. Pat. No. 4,545,970) and methods of producing relatively large particle size (2-40 mm) silicate-granulates with high solids content (≧75%) by reacting powdered calcareous and siliceous materials with steam (U.S. Pat. No. 4,394,176).

Another route to achieve a calcium silicate article with high solids content is to minimize the use of water in the various stages of production. These techniques aim to “gel” a portion of the calcareous and siliceous starting materials and then combine the balance of the formulation into the gel (U.S. Pat. No. 5,330,573). U.S. Pat. Nos. 4,523,955 and 4,477,397 describe a gel of calcium silicate that is further filter pressed to manufacture insulation products and finally PCT Patent No. WO 96/34839 describes the use of a “stabilizing reagent” for the manufacture of insulating materials.

The prior art listed above covers the possible formulations suitable to make Calsil as well as the ranges of autoclaving conditions suitable. Furthermore the pre-reaction of a calcareous and siliceous material to first form a gel and then further react the gel with additional siliceous material is covered by the prior art. However, the prior art does not address the direct manufacture of Calsil without the need for dewatering a slurry. Nor does the literature provide a method to make Calsil without having the need for an expensive stirred autoclave (ignoring U.S. Pat. No. 4,394,176 which specifically makes granulates). Nor does the literature provide a method to produce Calsil with fine particle size, ie not granulates, that is made with high solids content (again ignoring U.S. Pat. No. 4,394,176 for said reasons).

The Applicants have found that calcium silicate hydrate is an excellent density modification material in particular building products. Unfortunately, conventional production methods for calcium silicate hydrate provide the material in a slurry form with relatively low solids, e.g. up to about 10%. This slurry form of the low density additive is perfectly acceptable in processes which produce building materials, such as fibre reinforced cement composites, provided the process production techniques includes a dewatering step, e.g. Hatschek. Such a high water content, however, limits application of the low solids slurry form to other processes. For example, if the production process does not include a dewatering step, the slurry of low density additive must be dewatered prior to inclusion in the process. This can be accomplished by boiling off the excess moisture with agitation or filtration, and other drying processes. Clearly, such an initial dewatering step is energy intensive and consequently adds to the overall production costs.

In addition, transportation of the low solids slurry form is generally not viable since a large proportion of the cost relates to the weight of water included in the slurry. While the low solids slurry may be produced on site to avoid such transportation costs, this requires a stirred reaction vessel which in turn requires high capital investment.

It is an object of the present invention to overcome or ameliorate at least one of the disadvantages of the prior art, or to provide a useful alternative.

### SUMMARY OF THE INVENTION

In a first aspect, the present invention provides a method of producing calcium silicate hydrate comprising contacting calcareous material with siliceous material in an aqueous environment under elevated temperature and pressure and for a sufficient time to permit the calcareous material and siliceous material to react and form calcium silicate hydrate, wherein prior to said reaction, a predetermined quantity of a suspension agent is added to permit said reaction to take place with little or no agitation.

Preferably, in the above mentioned process, the components are combined as follows. A slurry of calcareous material is formed by mixing the calcareous material with water, preferably pre-heated water, to form a slurry of slaked lime. The suspension agent is also preferably mixed with water to form a slurry and optionally heated. For reasons discussed below, it is preferable that the suspension agent includes at least some silica, preferably, amorphous silica.

In a preferred embodiment, the suspension agent is a gel forming agent adapted to form a gel upon contact with the calcareous material and/or siliceous material, and or water.

The slaked lime slurry may be diluted further with water prior to being combined with the slurry of suspension agent to form a gel. In a preferred embodiment, the silica in the suspension agent can react with the calcium in the slaked lime slurry to assist in formation of the gel. This intermediate gel is then combined with the siliceous material and subjected to the elevated pressure and temperature to form calcium silicate hydrate. The siliceous material may be added to the intermediate gel in a dry powdered state or as a slurry. It is preferable to mix the siliceous material into the gel so that the material to undergo the reaction is essentially homogeneous. It is stressed, however, that the reaction between the slaked lime or calcareous material, and the siliceous material occurs without the need for agitation or mixing of the ingredients.

By suitable dosing with a suspension agent, the slaked lime and siliceous material remain in suspension allowing the reaction to form calcium silicate hydrate to be conducted without the need for agitation or mixing of the ingredients.

The resultant calcium silicate hydrate has a high solids content e.g. 35-60%.

In a second aspect, the present invention provides calcium silicate hydrate with a post-reaction solids content of greater than 35%. The term ‘post-reaction solids content’ refers to the solids content of the CSH material shortly after reaction without additional dewatering/drying.

The density of this calcium silicate hydrate product depends to a large extent on the quantity of siliceous material added. If a stochiometric quantity is used the resultant product has a bulk density of around 120-200 kg/m³. If excess silica is added, this raises the bulk density of the final product to as high as 380-460 kg/m³.

As will be appreciated by a person skilled in the art, the ability to produce calcium silicate hydrate without mixing is a significant advance over the prior art. Normally, calcium silicate hydrate must be formed in an autoclave with mixing/stirring. This can be quite expensive. The reaction is also, to a certain extent, unpredictable since another variable, i.e. level of mixing/agitation must be controlled. The preferred embodiments of the present invention provide an alternative to conventional techniques by producing calcium silicate hydrate without the need for agitation/stirring. The inventive process can be conducted in a conventional non-stirred autoclave.

It will be appreciated that while the preferred embodiments of the present invention do not require mixing or stirring, it is still suitable to be conducted in a stirred reaction vessel.

In a third aspect, the present invention provides for the use of a gel in the manufacture of calcium silicate hydrate, said gel being formed by combining a calcareous slurry with a gel forming agent over a predetermined temperature/pressure profile, the gel having a consistency such that upon combination with a siliceous material, the siliceous material is suspended therein for subsequent reaction with the gel at elevated pressure and temperature to form calcium silicate hydrate. Preferably, the gel forming agent is a source of amorphous silica such as diatomaceous earth or clay.

In another aspect, the present invention provides a reactable matrix comprising a calcareous gel with a homogeneous distribution of siliceous material suspended therethrough and adapted to be subjected elevated temperature and pressure and permit reaction between the calcareous gel and siliceous material to form calcium silicate hydrate.

In yet another aspect, the present invention provides for the use of a suspension agent in the manufacture of calcium silicate hydrate, the suspension agent being combined to with a calcareous component and a siliceous component to maintain said components in suspension and permit reaction between said components without the need for mixing or agitation.

### BRIEF DESCRIPTION OF THE DRAWINGS

FIG. 1 is a flow chart of a process for producing calcium silicate hydrate in accordance with an embodiment of the present invention

### DETAILED DESCRIPTION OF THE PREFERRED EMBODIMENTS

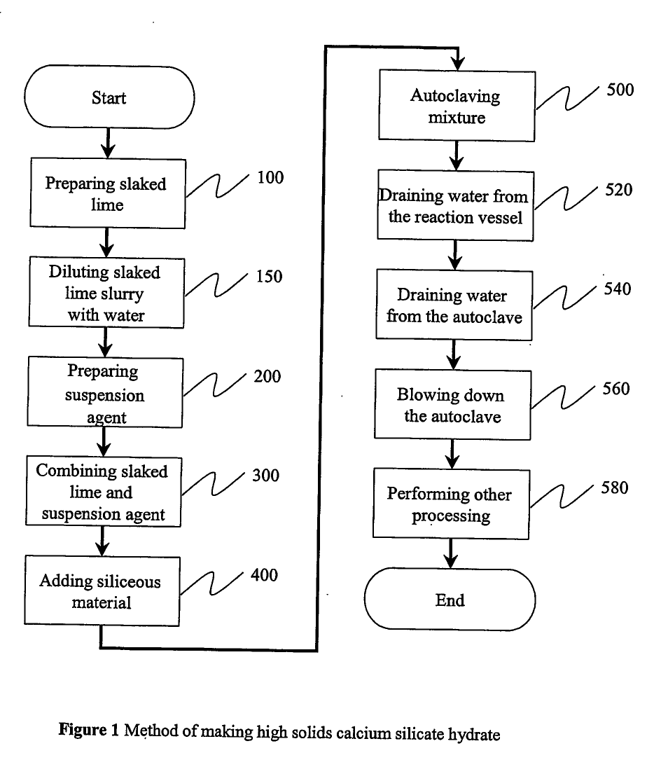

FIG. 1 illustrates a method of making high solids calcium silicate hydrate including the steps of:

Step 100: Preparing Slaked Lime

In this step, the slaked lime is prepared in the conventional manner. Any of the usual calcareous reactants may be used, but a preferred reactant is quicklime slaked to produce a large surface area. This may be accomplished by pulverizing quicklime to pass a standard 44μ (No. 325) mesh sieve, mixing this pulverized quicklime with about 4 times its weight of water and preferably with preheated water at about 100° C. Other calcium sources suitable for use with the preferred embodiments include lime, dolomitic limestone, calcitic limestone, carbide waste, seashells, and other known sources of calcium oxide.

A mixing time between about 5 and 30 minutes is typical and a basic mixing vessel with impeller is sufficient. High shear is not required for this step as only enough mixing is required to make the mixture homogenous and ensure no settling of the solids. The solids content is typically between about 10 and 50%, optimally about 20%.

Step 150: Diluting Slaked Lime Slurry with Water.

After slaking the lime, additional water if required is added to the slaked lime slurry. The amount of water is typically a further 6.5 times the water used in Step 100 to make the total slaked lime solids:water ratio approximately 1:26 w/w. The solids content is typically between about 2 and 6%, optimally about 3%. It should be noted, that such additional water is included to bring solids:water content to the desired value. It is of course possible to include all such water in the slaking step 100.

A mixing time between about 5 and 30 minutes is typical and the same mixing equipment used in step 100 is sufficient.

Step 200: Preparing Suspension Agent

In this step, a suspension agent is prepared by forming a high viscosity slurry with water and any other reactive gelling agent if needed. It will be appreciated that the suspension agent can be any material which forms a suspension or gel when contacted with the calcareous material, the siliceous material (discussed below) or water and thereby hold the reactant particles (silica and lime) in suspension without agitation can be used as a suspension agent. Suitable suspension agents include, but are not limited to: diatomaceous earth, silica fume or other amorphous silica containing material (lime is needed as the gelling agent for these), clay or other swelling siliceous materials or minerals, cellulose pulp or other similar materials, or a combination thereof. Depending on the suspension agent(s) used, it may be preferable to heat the suspension agent slurry before proceeding, for example when using diatomaceous earth the slurry can be heated to accelerate the gelling process, but when using clays there is no need for heating.

A preferred clay would be a high swelling grade of bentonite (11 mL of water absorbed per gram of clay). The slurry is prepared with a solids content typically between about 7 and 20%, optimally about 14%.

A mixing time between about 5 and 30 minutes is typical and a basic mixing vessel with impeller is sufficient. However, a high shear impeller is desirable to break apart agglomerates and fully disperse the particles.

Step 300: Combining Slaked Lime and Suspension Agent

In this step, the suspension agent slurry is added to the slaked lime slurry. The mixture is stirred at low speed to ensure there is no settling of the agglomerates. The solids content is less than about 5% w/w.

In this regard, while this embodiment shows the suspension agent being added first to the slaked lime and then subsequently, the siliceous material, it could equally be added simultaneously with the calcareous and siliceous material or indeed combined with the siliceous material first, for subsequent combination with a calcareous material.

The time it takes to form the gel varies with the suspension agent used and the temperature profile of the mixture. For example, when diatomaceous earth is used as a suspension agent, the suspension agent slurry is brought to a temperature close to about 100° C. and kept at the temperature with low speed stirring to form the gel which is primarily calcium silicate hydrate (CSH). When clay is used as the suspension agent the slurry is left for between about 15 minutes and 6 hours (preferably about 30 minutes) with no heating and slow speed or periodic stirring (about every 10 minutes). In either technique the slurry has the consistency of “bean curd” after about 30 minutes.

Suitable suspension agents include, but are not limited: diatomaceous earth, silica fume or other amorphous silica containing material, clay or other swelling siliceous materials or minerals, cellulose pulp or other similar materials, or a combination thereof.

Step 400: Adding Siliceous Material

In this step, further siliceous material is added to the gel formed in Step 300. Suitable siliceous sources include natural sources such as silica sand, diatomaceous earth, clay, silicic acid, quartzite dust, silicon dust or activated alumina. Preferably, ground quartz is used with a particle size D(90) of no more than about 70 micron. Note that the siliceous material added at this step could also be added in Step 200.

Depending on the intended use for the resultant product, it is possible to add more siliceous material than is necessary for a complete reaction if it is needed in the final product.

The siliceous material can be mixed into the gel in a dry powdered state or as a slurry. In either method the additional siliceous material should be mixed into the gel gently so as not to damage the gel, but the mixing should be thorough enough to ensure homogeneity.

Possible, preferred and optimal ranges of the raw materials used in the process of FIG. 1 are shown below in Table 1. The values shown are examples only and should in no way be considered limiting upon the present inventive process or product.

TABLE 1
Composition of matter for a high solids calcium silicate hydrate

| | | Possible | Preferred | Optimal |
|---|---|---|---|---|
| Composition | Example | range | range | value |
| Calcareous material (g) | Quicklime | 15-35 | 20-30 | 25 |
| Lime:Slake water ratio | — | 1:2 to 1:10 | 1:3 to 1:5 | 1:4 |
| Slake water (g) | Water | 50-250 | 75-125 | 100 |
| Excess water (g) | Water | 300-900 | 400-700 | 550 |
| Suspension agent (g) | Bentonite | 8-20 | 12-16 | 14 |
| | clay | | | |
| Suspension agent water | Water | 110-280 | 170-225 | 190 |
| (g) | | | | |
| Siliceous material (g) | Ground | 50-300 | 150-200 | 180 |
| | quartz | | | |
| | powder | | | |

Lime:Slake Water Ratio

Lime:slake water ratio is the ratio of the weight of the quick lime to the weight of the water used to hydrate or slake the lime. The Lime:slake water ratio could possibly be in the range of about 1:2 to 1:10; preferably in the range of about 1:3 to 1:5; and optimally about 1:4

Step 500: Autoclaving the Mixture

The combined mixture from step 400 is then subjected to elevated temperature and pressure, for example in an autoclave, for time sufficient to permit the reaction between the calcareous and siliceous materials to occur and form calcium silicone hydrate. The autoclave may be operated in a conventionally manner, however it is preferred to follow the predetermined temperature profile as laid out, for example, in Table 2.

TABLE 2
Autoclave temperature profile

| | Maximum | | |
|---|---|---|---|
| | Autoclave | Maximum | Autoclaving Time |
| | Temperature (° C.) | Pressure (kPa) | (min.) |
| Possible | 160-195 | 630-1400 | 60-840 |
| Preferred | 170-180 | 800-1000 | 100-360 |
| Optimal | 175 | 885 | 120 |

During the reaction in the autoclave, water is allowed to drain from the mixture (520) preferably for the entire reaction time. As the water is continually discharged from the slurry mixture throughout the reaction, the solids concentration gradually increases. In other words, the slurry dewaters as the reaction proceeds.

Water leaving the slurry mixture may be drained from the autoclave (540) via a steam trap. This removes free water in the system so the autoclave heat is used to evaporate water from the calcium silicate hydrate formed in the autoclaved. The heated water drained from the autoclaved may be recycled, if desired, and used to prepare slaked lime for the next batch of calcium silicate hydrate.

After an appropriate period within the autoclave, the autoclave pressure may be blown down (560) in a conventional manner following the temperature profile. This further evaporates water from the calcium silicate hydrate body to give it a semi-dry powder form. The resultant material is then removed from the autoclave.

The calcium silicate hydrate cake formed by this process can undergo further processing (580) e.g. further drying to remove further moisture, it may be packaged for later use or shipping or it may be stored and used immediately as a raw material to manufacture the product.

Typically properties of the resultant calcium silicate hydrate body are shown in Table 3.

TABLE 3
Properties of calcium silicate hydrate

| Property | Possible range | Preferred range | Optimal value |
|---|---|---|---|
| Feed molar Ca:Si | 0.05:1 to 0.75:1 | 0.1:1-0.2:1 | 0.15:1 |
| ratio^{¶} | | | |
| Reacted Ca:Si ratio | 0.3:1-1.4:1 | 0.7:1-1.0:1 | 0.83:1 |
| Water:Solids (total) | 1:1 to 7:1 | 1.25:1 to 4:1 | 1.5:1 |
| % A.I.R.^{¶} | 66-74% | 68-72% | 70% |
| Tamped dry bulk | 380-460 | 380-400 | 380 |
| density (kg/m³) | | | |
| DTA - | 824-840° C. | 824-840° C. | 824-840° C. |
| Wollanstonite | | | |
| conversion peak | | | |
| temperature | | | |
| Water Content % | 35-60% | 40-60% | 50% |

The feed ratio of Ca:Si and accordingly the % AIR will depend on the application of the material. Meaning that the feed ratio can be set to be in a stoichiometric ratio and so the % A.I.R. will be low, however, if excess silica is required in the final product then the % A.I.R. will be a higher value.

Feed Molar Ca:Si Ratio

Molar Ca:Si(total) is the molar ratio of all calcium to all silica. The feed molar Ca:Si ratio is dependent on the formulation of the application of the calcium silicate hydrate. It could possibly be in the range of about 0.05:1 to 0.75:1; preferably in the range of about 0.1:1 to 1:1; and optimally about 0.15:1 for the example given in Table 2 above.

Reacted Ca:Si Ratio

Reacted Ca:Si ratio is the molar ratio of all calcium to all reacted silica in the calcium silicate hydrate. The reacted Ca:Si ratio could possibly be in the range of about 0.3 to 1.4; preferably in the range of about 0.7 to 1.0; and optimally about 0.83.

Water:Solids (Total)

The water:solids (total) is the ratio of the weight of the water to the weight of the solids. The water:solids (total) could possibly be in the range of about 1:1 to 7:1; preferably in the range of about 1.25:1 to 4:1; and optimally about 1.5:1.

% Acid Insoluble Residue (A.I.R.)

% AIR is a measure of the unreacted quartz silica in the calcium silicate hydrate. The method involves grinding 2 grams of sample and making it into a paste with water and then diluting with water to 200 mL, then adding 25 mL of analytical reagent Hydrochloric acid 32% w/w, density 1.16 g/mL (1:1). The mixture is heated at 90-95° C. for 15 minutes and filtered through a No. 40 Whatman filter paper. The residue is washed with boiling water and boiling Na₂CO₃ (50 g/L). The residue and filter paper are then ignited at 900-1000° C., cooled in a desiccator, and the residue weighed. The residue mass expressed as a percentage of the initial sample mass is the % A.I.R.

Tamped Bulk Density

The calcium silicate hydrate is dried in an oven at 105° C. overnight and the dried cake is then broken up using a mortar and pestle and passed through 250 μm screens to remove lumps. Conglomerated material that fails to pass through the sieve is broken up by hand and sieved again. (100±1 cm³) of the sieved sample is placed in a preweighed measuring cylinder and then shaken on a vibrating table for 10 to 15 minutes with periodic stirring with a piece of wire. Once volume reduction has ceased, the volume and mass are recorded. The mass of the sample divided by the volume of the sample, expressed in kg/m³, is recorded as the Tamped Bulk Density.

DTA—Wollastonite Conversion Peak Temperature

Differential Thermal Analysis (DTA) is a method used to characterize calcium silicate hydrates. The test method involves heating approximately 30 mg of sample under nitrogen gas at a rate of 20° C. per minute from ambient to 1000° C. The difference in temperature between an empty reference sample holder and the temperature of the sample is measured. The tobermorite phase of calcium silicate hydrate is characterized by an exothermic conversion to wollastonite phase at temperatures between 824° C. and 840° C. Wollastonite conversion temperatures above 840° C. up to 900° C. are more typical of a reaction that has not proceeded to the tobermorite phase.

Water Content

The calcium silicate hydrate is dried in an automatic moisture balance for 30 minutes at 105° C. The water content is calculated as: ((wet mass−dry mass)/wet mass)×100. The water content of the sample is expressed as a percentage.

The calcium silicate hydrate produced according to the preferred embodiments of the present invention has a relatively high solids content as compared with the prior art. It is particularly suitable in a range of products and processes. From a quantity of calcium silicate hydrate per dollar, it is also cheaper to transport since it does not contain the high water content of conventional calcium silicate hydrate slurries.

Persons skilled in the art will be aware of various apparatus which may be suitable for carrying out the present invention. Any vessel which can hold the calcareous material, siliceous material and suspension agent is suitable. The vessels may optionally include detwatering apparatus if necessary. After depositing the mixture of calcareous material and siliceous material with suspension agent into the vessel, the vessel may be placed in the autoclave. Upon entering the autoclave vessel and being subjected to elevated temperature and pressure according to the predetermined temperature profile discussed above, the calcareous material and siliceous material react to form calcium silicate hydrate and optionally water drains from the calcium silicate hydrate.

The vessel is typically made of steel, but can be made of any material that can withstand the temperature and pressure of the autoclave and the chemical reaction of the calcium silicate hydrate.

While the present mentioned has been described with reference to the above examples, it will be appreciated that other embodiments, forms or modifications may be produced without departing from the spirit or scope of the invention as broadly described herein.

1-34. (canceled)

35. A method of producing calcium silicate hydrate comprising contacting calcareous material with siliceous material in an aqueous environment under elevated temperature and pressure and for a sufficient time to permit the calcareous material and siliceous material to react and form calcium silicate hydrate, wherein
prior to said reaction, a predetermined quantity of a suspension agent is added to permit said reaction to take place with little or no agitation.

36. A method as claimed in claim 35 wherein the calcareous material is mixed with water to form a slurry of slaked lime prior to addition of a suspension agent and/or siliceous material.

37. A method as claimed in claim 36 wherein the water used to form the slurry is preheated.

38. A method as claimed in claim 35 wherein the suspension agent is mixed with water to form a slurry prior to being mixed with a calcareous and/or siliceous material.

39. A method as claimed in claim 38 wherein the water used to form the slurry is preheated.

40. A method as claimed in claim 35 wherein the suspension agent is a gel forming agent adapted to form a gel upon contact with the calcareous material, siliceous material and/or water.

41. A method as claimed in claim 40 wherein the gel forming agent is a source of amorphous silica.

42. A method as claimed in claim 40 wherein the gel forming agent is selected from the group consisting of diatomaceous earth, clay, silica fume, cellulose pulp or mixtures thereof.

43. A method as claimed in claim 40 wherein the gel forming agent is combined with a slaked lime slurry, optionally further diluted with water, and allowed to react to form a gel, and subsequently combined with the siliceous material and subjected to elevated temperature and pressure to form calcium silicate hydrate.

44. A method as claimed in claim 35 wherein the siliceous material is combined with the calcareous material and suspension agent in a dry powdered state or as a slurry.

45. A method as claimed in claim 40 wherein the siliceous material is mixed into the gel to provide an essentially homogeneous reactive mixture.

46. A calcium silicate hydrate with a post reaction solids content of greater than 35% wt

47. A calcium silicate hydrate as claimed in claim 46 having a post reaction solids content between 35% to 60% wt.

48. A calcium silicate hydrate as claimed in claim 46 wherein about stoichiometric quantities of calcareous material and siliceous material are reacted to form the calcium silicate hydrate such that the resultant product has a bulk density of around 120 to 200 kg/m³.

49. A calcium silicate hydrate as claimed in claim 46 wherein excess silica is added to the calcareous and siliceous reactants such that the resultant product has a bulk density of up to about 380 to 460 kg/m³.

50. A calcium silicate hydrate with a post reaction solids content of greater than 35% wt and produced according to the method of claim 35.

51. A method of manufacturing calcium silicate hydrate comprising using a gel, said gel being formed by combining a calcareous slurry with a gel forming agent over a predetermined temperature/pressure profile, the gel having a consistency such that upon combination with a siliceous material, the siliceous material is suspended therein for subsequent reaction with the gel at elevated pressure and temperature to form calcium silicate hydrate, without the need for mixing or agitation.

52. A method as claimed in claim 51 wherein the gel forming agent is a source of amorphous silica.

53. A method as claimed in claim 51 wherein the gel forming agent is selected from the group consisting of diatomaceous earth, clay, silica fume, cellulose pulp or mixtures thereof.

54. A method as claimed in claim 51 wherein the siliceous material is mixed into the gel to provide an essentially homogeneous reactive mixture.

55. A method as claimed in claim 51 wherein the siliceous material is combined with the gel in a dry powdered state or as a slurry.

56. A reactable matrix comprising a calcareous gel with a homogeneous distribution of siliceous material suspended therethrough and adapted to be subjected to elevated temperature and pressure and permit reaction between the calcareous gel and siliceous material to form calcium silicate hydrate.

57. A reactable maxtrix as claimed in claim 56 wherein the calcareous gel is produced by combining a calcareous material with a gel forming agent, optionally diluted with water and allowed to react to form a gel.

58. A reactable matrix as claimed in claim 56 wherein the siliceous material is mixed into the gel to provide an essentially homogeneous reactable matrix.

59. A reactable matrix as claimed in claim 56 wherein the siliceous material is combined with a calcareous gel in a dry powdered state or as a slurry.

60. A method of manufacturing calcium silicate hydrate comprising using a suspension agent, the suspension agent being combined in sufficient quantities with a calcareous material and a siliceous material to maintain said components in suspension and thereby permit reaction between said materials without the need for mixing or agitation.

61. A method as claimed in claim 60 wherein the calcareous material is mixed with water to form a slurry of slaked lime prior to addition of a suspension agent and/or siliceous material.

62. A method as claimed in claim 61 wherein the water used to form the slurry is preheated.

63. A method as claimed in claim 60 wherein the suspension agent is mixed with water to form a slurry prior to being mixed with a calcareous and/or siliceous material.

64. A method as claimed in claim 63 wherein the water used to form the slurry is preheated.

65. A method as claimed in claim 60 wherein the suspension agent is a gel forming agent adapted to form a gel upon contact with the calcareous material, siliceous material and/or water.

66. A method as claimed in claim 65 wherein the gel forming agent is a source of amorphous silica.

67. A method as claimed in claim 65 wherein the gel forming agent is selected from the group consisting of diatomaceous earth, clay, silica fume, cellulose pulp or mixtures thereof.

68. A method as claimed in claim 65 wherein the gel forming agent is combined with a slaked lime slurry, optionally further diluted with water, and allowed to react to form a gel which is subsequently combined with the siliceous material and subjected to elevated temperature and pressure to form calcium silicate hydrate.

69. A method as claimed in claim 60 to wherein the siliceous material is combined with a calcareous material and suspension agent in a dry powdered state or as a slurry.

70. A method as claimed in claim 65 wherein the siliceous material is mixed into the gel to provide an essentially homogeneous reactive mixture.
